(19) United States
(12) Patent Application Publication
(10) Pub. No.: US 2015/0104067 A1
(43) Pub. Date: Apr. 16, 2015

(54) METHOD AND APPARATUS FOR TRACKING OBJECT, AND METHOD FOR SELECTING TRACKING FEATURE

(71) Applicant: Liyan LIU, Beijing (CN)

(72) Inventor: Liyan LIU, Beijing (CN)

(73) Assignee: Ricoh Company, Ltd., Tokyo (JP)

(21) Appl. No.: 14/511,657

(22) Filed: Oct. 10, 2014

(30) Foreign Application Priority Data
Oct. 14, 2013 (CN) 201310479162.3

(51) Int. Cl. G06K 9/00; G06K 9/62; G06T 7/20

(52) U.S. Cl. CPC G06K 9/00624; G06T 7/2033; G06K 9/6256
USPC 382/103

(57) ABSTRACT

A method and an apparatus for tracking an object, and a method for selecting a tracking feature are disclosed. The object tracking method includes tracking, based on a previously selected first tracking feature, the object in a sequence of video frames having the object; when a scene of the video frame is changed, selecting a second tracking feature with optimal tracking performance for the changed scene; and continuing tracking the object based on the selected second tracking feature. According to the object tracking method, a feature with optimal tracking performance for a corresponding scene can be dynamically selected in response to the changed scene in the tracking of a hand, thus it is possible to perform accurate tracking.

### BACKGROUND OF THE INVENTION

1. Field of the Invention

The present invention generally relates to human-computer interaction, and specifically, a method and an apparatus for tracking an object in human-computer interaction.

2. Description of the Related Art

Object tracking is a very important and essential part in the human-computer interaction field. Currently, as an example of the object tracking, hand tracking is being studied, and methods for tracking a hand, such as a tracking method based on color features of the hand, a tracking method based on depth features of the hand or the like are provided.

However, the hand is a non-rigid object, and phenomena of shape deformation and shape inconsistency may occur during a motion process. Furthermore, the motion of a hand has some peculiar features, and for example, the motion velocity of a hand may constantly change and hand information in an image may blur due to a rapid motion of the hand. Thus, it is difficult to find a single feature of a hand that has an optimal tracking effect for all of the scenes during a whole motion process of a hand.

U.S. Pat. No. 8,213,679B2 discloses a method for moving targets tracking and number counting. In this method, matching degree between a target region of a current frame and a target region of a previous frame is calculated based on all features in a pre-established feature pool, and an overall matching degree is further calculated based on a feature with maximum matching degree. By this method, different features may be used to perform tracking for different video frames during the motion process of an object. However, in this method, complicated matching calculation is performed for both of two video frames, the calculation amount is large and the processing speed is slow.

### SUMMARY OF THE INVENTION

According to an aspect of an embodiment of the present invention, a method for tracking an object includes tracking, based on a previously selected first tracking feature, the object in a sequence of video frames having the object; when a scene of the video frame is changed, selecting a second tracking feature with optimal tracking performance for the changed scene; and continuing tracking the object based on the selected second tracking feature.

According to another aspect of an embodiment of the present invention, an apparatus for tracking an object includes a feature selection unit configured to select a tracking feature with optimal tracking performance for a changed scene and notify a tracking unit of the tracking feature, when the scene of a video frame is changed; and the tracking unit configured to track, based on the selected tracking feature, the object in a sequence of the video frames having the object.

According to another aspect of an embodiment of the present invention, a method for selecting a tracking feature used for tracking an object includes selecting the tracking feature with optimal tracking performance for a changed scene, in response to a change of the scene of a video frame having the object.

According to the object tracking technology and the tracking feature selection technology of the embodiments of the present invention, a feature with optimal tracking performance for a corresponding scene can be dynamically selected in response to the changed scene, thus it is possible to perform accurate tracking.

### BRIEF DESCRIPTION OF THE DRAWINGS

FIG. 1 is a schematic drawing illustrating a scene to which object tracking technology according to an embodiment of the present invention can be applied to;

FIG. 2 is a flowchart illustrating an object tracking method according to the embodiment of the present invention;

FIG. 3 is a flowchart illustrating a tracking method for a hand in a sequence of video frames having the hand by using a previously selected tracking feature according to an embodiment of the present invention;

FIG. 4 is a schematic drawing illustrating feature distributions of two different tracking features in a whole training data set;

FIG. 5 is a schematic drawing illustrating a comparison between tracking performance of two different features in the training data set when the tracking performance is represented by tracking error;

FIG. 6 is a flowchart illustrating selecting a tracking feature with optimal tracking performance for the changed scene when a scene in the video frame is changed according to an embodiment of the present invention;

FIG. 7 is a schematic drawing illustrating applying a tracking method according to an embodiment of the present invention;

FIG. 8 is a functional configuration block diagram illustrating an object tracking apparatus according to an embodiment of the present invention;

FIG. 9 is an overall hardware block diagram illustrating an object tracking system according to an embodiment of the present invention.

### DETAILED DESCRIPTION OF THE PREFERRED EMBODIMENTS

In the following, embodiments of the present invention are described in detail with reference to the accompanying drawings, so as to facilitate the understanding of the present invention.

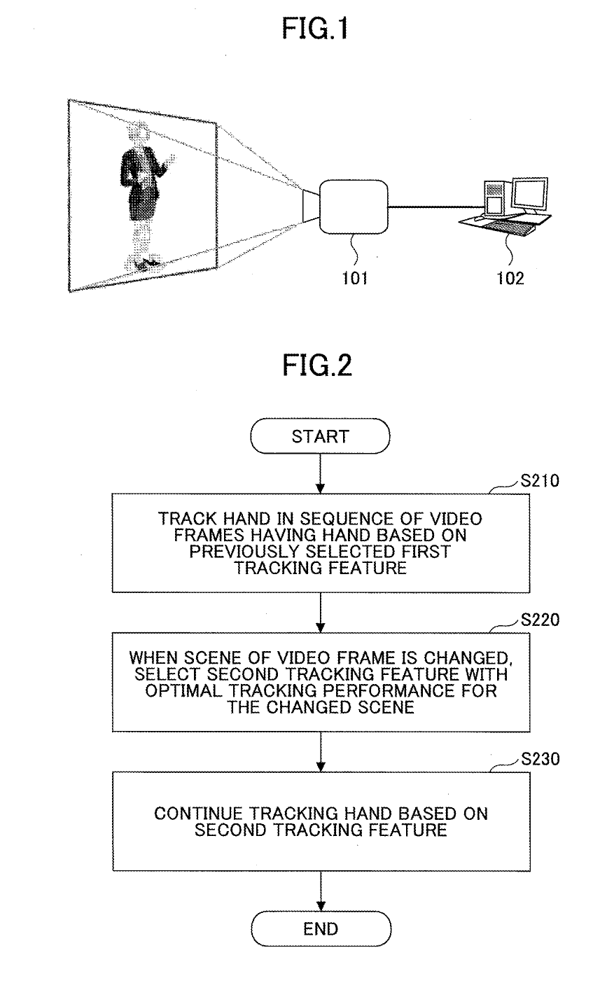

FIG. 1 is a schematic drawing illustrating a scene to which object tracking technology according to an embodiment of the present invention can be applied. As illustrated in FIG. 1, a user stands within an imaging range of a camera 101, and the camera 101 images the user. The camera 101 may be a camera providing only color images, and may also be a camera providing both color images and depth images, such as Primesense, Kinect or the like. When the user moves his/her hand in the imaging range of the camera 101, a processing apparatus 102 such as a computer may select appropriate features to track the hand based on video frames picked up by the camera 101, and output positions of the hand in the video frames. It should be noted that, FIG. 1 merely illustrated an example of the application scene of the present invention, and the apparatuses in the application scene may be increased or decreased, and may have different configurations according to the actual situation.

For convenience of explanation, as an example of the object tracking, the hand tracking technology according to an embodiment of the present invention will be described below.

First, the basic concept of the hand tracking technology according to the present invention will be described briefly. As described above, the hand is a non-rigid object, and has characteristics of speedily moving and easily deforming. Thus, it is difficult to find a single feature of a hand that can obtain optimal tracking effect for all of the scenes during a whole motion process of a hand. For this situation, the present invention provides tracking technology of dynamically selecting a feature fit for a current scene in response to the changed specific scene during the tracking process of a hand. For example, when the hand moves rapidly, information of rough edges of the hand is unclear or lost; and for this scene, a color feature has good distinction effect. Accordingly, when this scene occurs during a tracking process, it may be considered that a color feature is dynamically selected to perform the tracking. As another example, when the hand moves in the vicinity of a face, the distinction degree of the color feature is reduced since the color of the hand and the face are similar; meanwhile, a depth feature shows its good distinction effect. Accordingly, when this scene occurs during a tracking process, it may be considered that a depth feature is dynamically selected instead of a color feature to perform the tracking. Furthermore, for some scenes, not only a single feature but also a combination of features may be selected for hand tracking. In this way, a feature fitting for a current scene can be dynamically selected in response to the changed scene during the tracking process of a hand, thus it is possible to perform accurate tracking.

FIG. 2 is a flowchart illustrating an object tracking method according to the embodiment of the present invention.

As illustrated in FIG. 2, in step S210, tracking is performed for a hand in a sequence of video frames having the hand, based on a previously selected first tracking feature.

Tracking features are features that represent characteristics of a hand and can provide good tracking performance during the tracking of a hand. The tracking features may be a color feature or depth feature described above, and may also be an edge feature, a grayscale feature or the like.

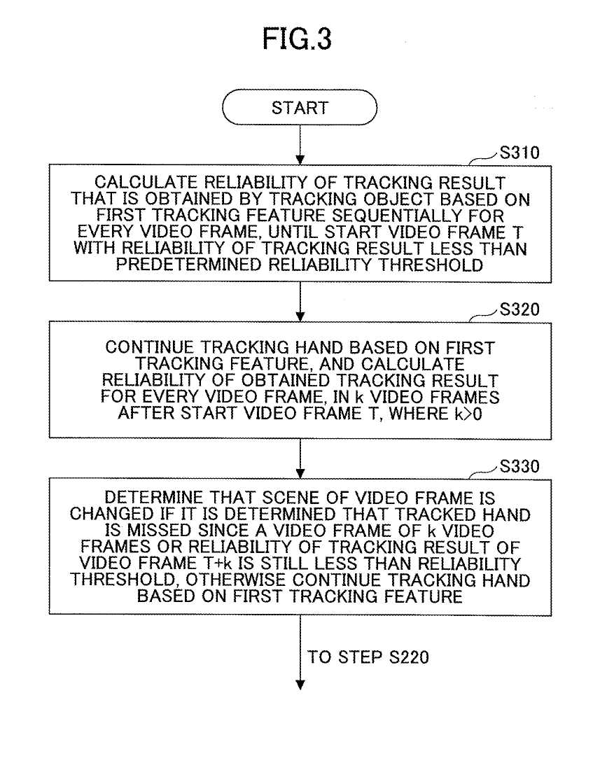

In this step, the first tracking feature for the tracking may be a previously selected tracking feature fitting for a current scene, and may also be a tracking feature selected by any other appropriate methods. In the following, the processing of step S210 will be described with reference to FIG. 3.

As illustrated in FIG. 3, in step S310, reliability of a tracking result that is obtained by tracking the object based on the first tracking feature is calculated sequentially for every video frame, until a start video frame T with the reliability of the tracking result less than a predetermined reliability threshold. The reliability of the tracking result of a previous video frame T-1 of the start video frame T is greater than or equal to the reliability threshold.

The specific tracking processing based on the first tracking feature may be performed by any known methods, such as a Kalman filtering method, a particle filtering method or the like, and the detailed description is omitted here.

The tracking of the hand according to the embodiment of the present invention is a real-time and online process. In this step, for each of the obtained video frames with the hand, the tracking of the hand is performed in real time by using the first tracking feature, and the reliability of the tracking result that is obtained by the tracking is calculated, until a start video frame T whose tracking performance starts to fall appears; namely, the reliability of the tracking result in the video frame T based on the first tracking feature is less than a predetermined reliability threshold, and the reliability of the tracking result in a video frame T-1 is greater than or equal to the reliability threshold. The reliability reflects reliable degree of the tracking result. Specifically, the reduction of the reliability indicates that the tracking performance of the currently selected tracking feature reduces; that is to say, the currently selected tracking feature does not fit for the scene of the current video frame, namely, a change of scene occurs. For example, in the first 100 frames, a color feature is still used as a tracking feature to perform the tracking, and the tracking performance of all frames is relatively high; whereas in the 101th frame, the hand moves to the vicinity of the face, and the distinction degree of the color feature reduces since the colors of the hand and the face are similar. Accordingly, the reliability of the tracking result when the tracking is performed by using the color feature in the 101th frame reduces, and the tracking performance reduces; namely, the 101th frame is the start video frame T whose tracking performance starts to fall, as described above.

The reliability may be calculated by any appropriate methods. Considering that color distance and position distance of the hand between two adjacent frames in the same scene do not vary so much, an example of a method for calculating the reliability is as follows.

Confidenceᵢ=1/(D(Colorᵢ, Colorᵢ₋₁)+D(Posᵢ, Posᵢ₋₁)) (1)

where Confidenceᵢ represents the reliability of the tracking result of the i-th frame, D(colorᵢ, colorᵢ₋₁) represents the color distance between the i-th frame and the (i−1)-th frame, and D(Posᵢ, Posᵢ₋₁) represents the position distance between the i-th frame and the (i−1)-th frame. The color distance and the position distance may be calculated by using any appropriate methods. For example, as a method for calculating the color distance, a distance of a color histogram of a tracking region of the tracked hand between two adjacent frames, such as a Bhattacharyya distance is calculated; and as a method for calculating the position distance, an Euclidean distance of a position of the tracked hand between two adjacent frames is calculated. If the Confidenceᵢ is less than a predetermined reliability threshold, it is determined that the tracking performance of the currently selected tracking feature in the i-th frame has fallen. The reliability threshold may be set by experience according to a specific application environment.

Returning to FIG. 3, in step S320, the tracking of the hand based on the first tracking feature is still continued, and the reliability of the obtained tracking result is calculated for every video frame, in k video frames after the start video frame T, where k>0.

As described in above step S310, since the tracking scene changes, the start video frame T whose tracking performance reduces appears. However, in actuality, interference such as noise in the obtained video frames may be the reason that the tracking performance in the video frame T reduces. Accordingly, in step S320, after the start video frame T whose tracking performance reduces appears, it is not necessary to change the tracking feature immediately, and an “allowable period” is set. In the “allowable period”, the first tracking feature is still used for the tracking of the hand, and it is observed whether the tracking performance gets better. The “allowable period” may be set by experience according to a specific tracking environment, for example, the “allowable period” may be k video frames after the start video frame T whose tracking performance reduces, where k>0. In step S330, it is determined that the scene of the video frame is changed, if the tracked hand is missed since a video frame of the k video frames or the reliability of the tracking result of the video frame T+k is still less than the reliability threshold; otherwise the tracking is continued based on the first tracking feature.

In this step, a process is performed based on the tracking results in the k video frames using the first tracking feature. Specifically, if the tracked hand is missed (i.e., tracking failure) since a video frame of the k video frames, or the reliability of the tracking result of the video frame T+k is still less than the reliability threshold, namely, the tracking performance still does not get better after the “allowable period” is over, it is determined that the scene has been changed, and good tracking performance cannot be obtained by using the first tracking feature in the current scene. On the contrary, if the tracking performance gets better, for example, the reliability becomes greater than or equal to the reliability threshold since a video frame in the “allowable period” and the reliability of subsequent frames are still greater than or equal to the reliability threshold, it is determined that good tracking performance can be obtained by using the first tracking feature in the current scene; thus the first tracking feature can still be used for the tracking.

Returning to FIG. 2, in step S220, when the scene of the video frame is changed, a second tracking feature with the optimal tracking performance for the changed scene is selected.

When the scene of the video frame is changed and good tracking performance cannot be obtained based on the first tracking feature in the changed scene, in step S220, the tracking feature with the optimal tracking performance for the changed scene may be selected by any appropriate methods. As an example, the second tracking feature with the optimal tracking performance for the changed scene may be selected based on previously calculated tracking performance of each of the tracking features in each of the scenes of a training data set. The training data set consists of training video frames in the scenes, and the training video frames include the hand. In this example, the tracking performance of each of the tracking features in each of the scenes is previously calculated; thus, after the changed scene is determined, it is easy to select the tracking feature with the optimal tracking performance for the changed scene. The tracking performance of each of the tracking features in each of the scenes may be previously calculated by any known methods in the art; for the complete description, an example will be described briefly.

First, a feature pool is constructed. The feature pool includes features that can have good tracking performance in the tracking of a hand, for example, a single feature such as color feature, depth feature, edge feature, grayscale feature or the like, and a combination feature of a plurality of the single features. Furthermore, the training data is collected and a training data set is established. It should be noted that, the training data set may cover as many different scenes relating to the motion of the hand as possible, and specifically, different scenes relating to the motion of the hand in the human-computer interaction field. Next, the training data (including video frames of the hand) is classified according to the scenes relating to the motion of the hand. The scenes relating to the motion of the hand include, for example, a scene in which the hand moves rapidly, a scene in which the hand moves to the vicinity of the face or the like. It should be noted that, these two scenes are just examples, and the number and the type of the specific scenes may be set according to the actual application.

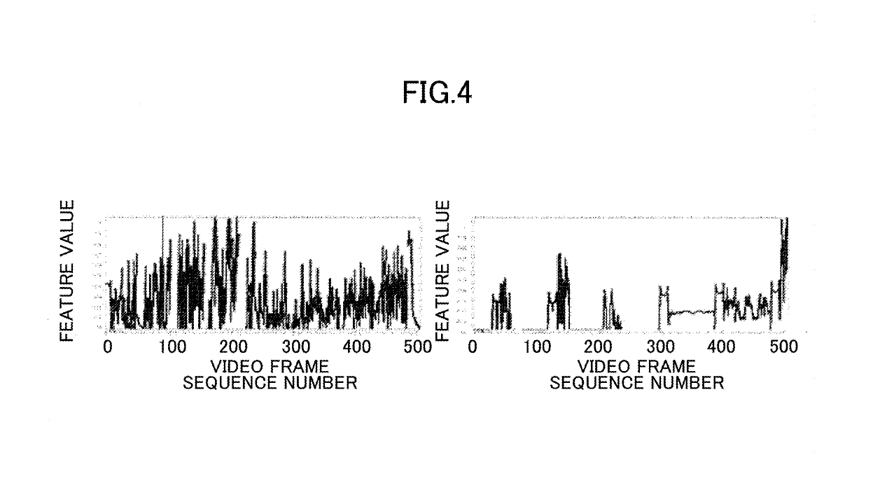

After the training data is classified according to the different scenes, for each of the video frames in each of the scenes, a position of the hand in the video frame is artificially marked, as ground truth, by drawing a hand region using a rectangular frame or drawing a center position using points. Furthermore, for each of the scenes, feature distribution of each of the features in the feature pool is calculated. The feature distribution reflects a specific value of the tracking feature in each of the frames in the scene. For example, when a depth value is used as the tracking feature, the specific value in each of the frames is a depth value of the detected hand in each of the frames. For example, FIG. 4 is a schematic drawing illustrating feature distributions of two different tracking features in a whole training data set.

After the training data is classified according to different scenes, an offline tracking of the hand is performed for all of the scenes, by using the features in the feature pool. For example, if there are r features (single features or combination features) in the feature pool, the tracking of the hand is performed for each of the r features, and the tracking of the hand is performed for all of the scenes. And then, for each of the tracking features, average tracking performance in each of the scenes is calculated. The tracking performance is represented by parameters or the combination thereof, such as tracking accuracy, tracking error, number of times of tracking failure (missing the tracking object) or the like. For example, as illustrated by the following expression (2), the average tracking performance is represented by the combination of the tracking error and the number of times of tracking failure.

$$Avg \text{.} {PR}_{m} = \frac{{\sum }_{i = 1}^{n} {error}_{i}}{n} \times \frac{1 + {losstimes}_{m}}{n} \qquad ( 2 )$$

where, Avg.PRₘ represents average tracking performance of a feature in a scene m, errorᵢ represents tracking error of the feature in a i-th frame of the scene m, the tracking error may be represented by a distance between an artificially marked ground truth of a position of the hand in the video frame and an offline-tracked position of the hand in the video frame, n is the number of the video frames of the scene m in the training data set, and losstimesₘ represents the number of tracking failures of the feature in the scene m. The smaller Avg.PRₘ calculated by the expression (2) is, the better the tracking performance of the feature is.

Thus, the tracking performance of the tracking features in the scenes can be previously calculated according to the above expression (2). It should be noted that, the expression (2) may also be expanded to the whole training data set, namely, average tracking performance of the features may also be calculated for the whole training data set.

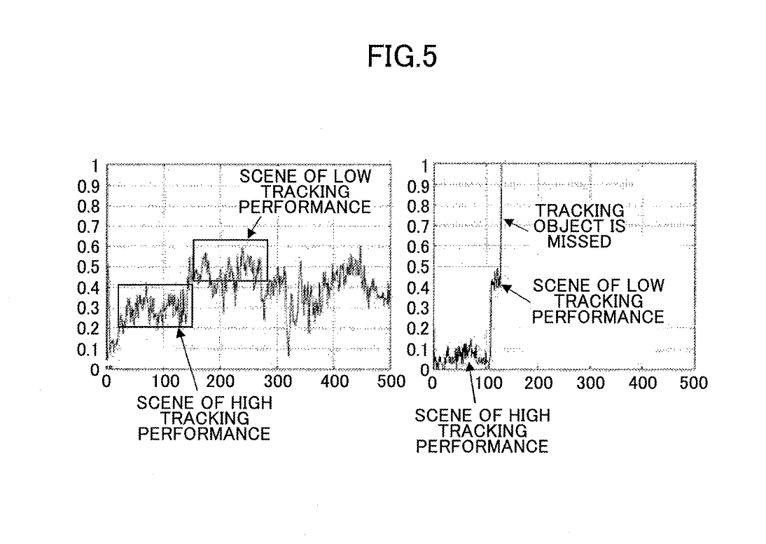

FIG. 5 is a schematic drawing illustrating a comparison between tracking performance of two different features in the training data set when the tracking performance is represented by tracking error. In FIG. 5, the horizontal axis represents the sequence number of the video frames, and the vertical axis represents the tracking error of the feature. The left drawing illustrates tracking performance of the feature q in the training data set; and as illustrated in the left drawing, the tracking performance of the feature q varies in response to the scenes. The right drawing illustrates tracking performance of the feature p in the training data set; and as illustrated in the right drawing, at about 100th frame, the tracking error sharply increases and the tracking performance sharply falls, and then the tracking object is missed and the tracking fails.

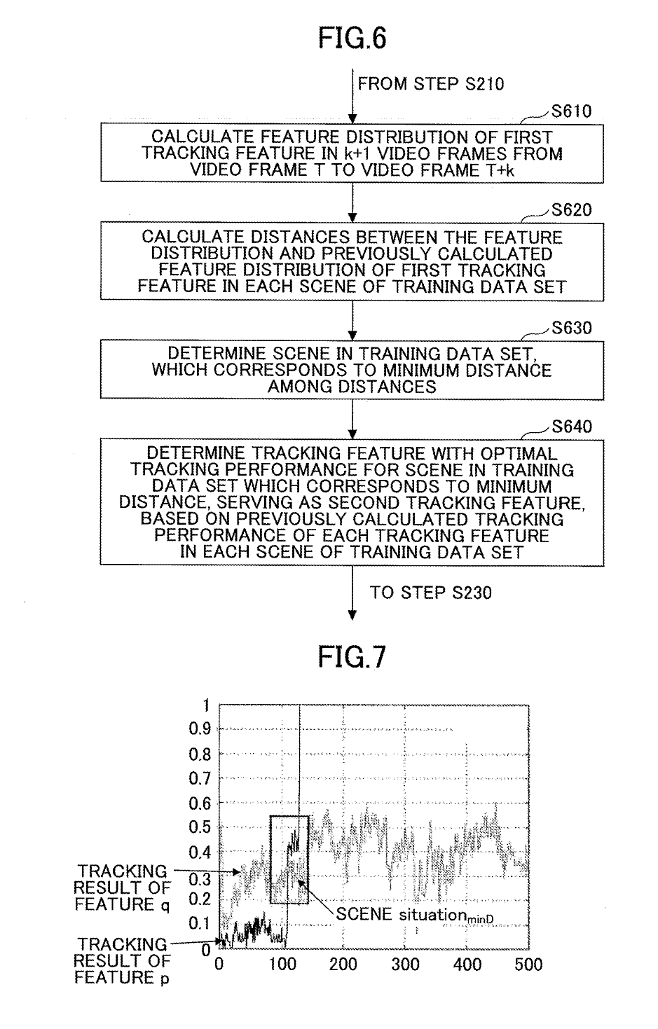

Returning to step S220, as described above, in this step, it is only necessary to determine what the scene is changed to; and the feature with the optimal tracking performance for the changed scene can be selected by the previously calculated tracking performance of the tracking features in the scenes. The detailed steps will be described with reference to FIG. 6 as follows.

As illustrated in FIG. 6, in step S610, the feature distribution of the first tracking feature in k+1 video frames from the video frame T to the video frame T+k is calculated.

In step S620, distances between the feature distribution and the previously calculated feature distribution of the first tracking feature in each of the scenes of the training data set are calculated.

As described above, in the k+1 video frames from the video frame T to the video frame T+k, good tracking performance cannot obtained by using the first tracking feature, thus it is determined that the scene has changed since the video frame T. Here, for convenience of explanation, a current scene that has been changed is represented by Situation_{current}. Furthermore, as described above, for each possible scene, distribution of each possible feature in the feature pool is previously calculated.

Accordingly, in step S620, the corresponding distances between the feature distribution of the first tracking feature in the k+1 video frames and the feature distribution of the first tracking feature in each of the scenes of the training data set can be calculated.

In step S630, the scene in the training data set, which corresponds to a minimum distance among the distances, is determined.

In this step, the minimum distance among the corresponding distances calculated in step S620 is determined, and the scene Situation_{minD} in the training data set, which corresponds to the minimum distance, is determined. The scene may be represented by the following expression.

Situation_{minD}=_{iε(1,M)}^{Min}(D(feature_{1 Situation}_{_{current}}, feature_{1 Situation}_{ᵢ})) (3)

Where, M is the number of the scenes in the training data set, D(feature_{1 situation}_{_{current}}, feature₁ situationᵢ) is the distance between the feature distribution of the first tracking feature in the scene Situation_{current} and the feature distribution of the first tracking feature in i-th scene Situationᵢ of the training data set. The distance between the feature distributions may be calculated by any known methods in the art, and the description thereof is omitted here. It should be noted that Situation_{minD} is a scene in the scenes of the training data set, which is identical or most similar to the changed current scene Situation_{current}.

In step S640, the tracking feature with the optimal tracking performance for the scene in the training data set which corresponds to the minimum distance is determined, based on the previously calculated tracking performance of each of the tracking features in each of the scenes of the training data set, serving as the second tracking feature.

As described above, the average tracking performance Avg.PR of the tracking feature in the scenes is previously calculated according to the expression (2), thus the tracking feature with the optimal tracking performance for the scene Situation_{minD} can be easily determined, serving as the second tracking feature with the optimal tracking performance for the changed current scene Situation_{current}.

It should be noted that, in step S610, it is the feature distribution of the first tracking feature in the k+1 video frames from the video frame T whose reliability becomes the reliability threshold; however, it is just an example. Specifically, the feature distribution in a plurality of video frames from several frames before or after the video frame T to the video frame T+k may be calculated, and alternatively, the feature distribution in a video frame sequence of more than or less than k+1 video frames may also be calculated.

Additionally, in the above description relating to FIG. 6, the changed current scene Situation_{current} is determined according to the feature distribution of the tracking features in the video frames; however, it is also just an example, and the changed current scene Situation_{current} may be determined by using other appropriate parameters, such as an optical flow feature.

Returning to FIG. 2, in step S230, the tracking of the hand is continued based on the second tracking feature.

As described above, the tracking of the hand according to the embodiment of the present invention is a real-time online tracking process. Thus, after the second tracking feature is selected, in step S230, for each of the video frames having the hand in which the scene has changed, the tracking of the hand is continued in real time based on the second tracking feature. The specific tracking processing based on the second tracking feature may be performed by using any known methods, and the detailed description is omitted here.

The method for tracking a hand according to the embodiment of the present invention is described above. According to the method, a feature with optimal tracking performance for a corresponding scene can be dynamically selected in response to the changed scene in the tracking process of the hand; thus it is possible to perform accurate tracking.

FIG. 7 is a schematic drawing illustrating applying a tracking method according to an embodiment of the present invention. As illustrated in FIG. 7, since about 100th frame, the tracking performance of the tracking feature p falls rapidly, and the tracking object is missed soon. In this case, it is necessary to perform the tracking by using a feature fitting the changed scene. By calculation and comparison, it is determined that the scene situation_{minD} in the training data set is most similar to the scene that has changed from the about 100th frame, and the feature q has the optimal tracking performance for the scene situation_{minD}. Accordingly, the feature q is used as the tracking feature to continue the tracking.

It should be noted that, in the whole tracking process applying the tracking method according to the embodiment of the present invention, when the scene is changed, a feature most fitting the changed scene is dynamically selected to perform the tracking; however, for a first video frame at the start of the tracking, the scene cannot be predicted, thus the most fitting feature cannot be previously selected. Accordingly, for a first video frame at the start of the tracking, the tracking may be performed based on the tracking feature with optimal average tracking performance in the whole training data set. The tracking feature with optimal average tracking performance in the whole training data set may be calculated by using the expanded expression (2) as described above.

Additionally, as an example of the tracking object, a hand is tracked; however, the object tracking method according to the present invention is not limited to the hand tracking, and may be applied to the tracking for other objects.

Furthermore, an embodiment of the present invention may also provide a tracking feature selecting method in real-time object tracking. In this method, the tracking feature with optimal tracking performance for a changed scene is selected in response to a change of the scene of a video frame having the object. The specific processing of the selecting step may refer to the descriptions of FIGS. 1 to 7, and the descriptions thereof are omitted here. According to the tracking feature selecting method, the tracking feature used in real-time object tracking is always the feature most fitting the scene, and relatively good tracking performance can be obtained.

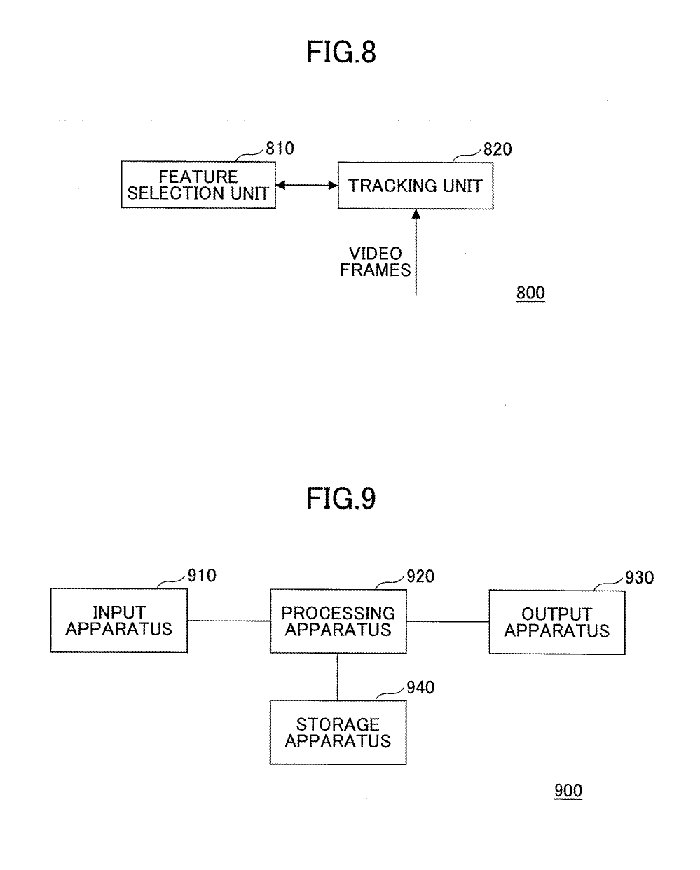

In the following, an object tracking apparatus according to an embodiment of the present invention will be described with reference to FIG. 8.

FIG. 8 is a functional configuration block diagram illustrating an object tracking apparatus 800 according to an embodiment of the present invention.

As illustrated in FIG. 8, the object tracking apparatus 800 includes a feature selection unit 810 configured to select a tracking feature with optimal tracking performance for a changed scene and notify a tracking unit 820 of the tracking feature, when the scene of a video frame is changed; and the tracking unit 820 configured to track, based on the selected tracking feature, the object in a sequence of the video frames having the object.

The detailed functions and operations of the above feature selection unit 810 and tracking unit 820 may refer to the descriptions in FIGS. 1 to 7, and the descriptions thereof are omitted here.

FIG. 9 is an overall hardware block diagram illustrating an object tracking system 900 according to an embodiment of the present invention. As illustrated in FIG. 9, the object tracking system 900 may include an input apparatus 910 for inputting related images and information from the outside such as video frames picked up by a camera, for example, including a keyboard, a mouse, a communication network and a remote input device connected thereto, etc.; a processing apparatus 920 for implementing the above object tracking method according to the embodiments of the present invention, or being implemented as the above object tracking apparatus according to the embodiments of the present invention, such as CPU of a computer or other chips having processing ability, etc.; an output apparatus 930 for outputting the result, such as the determined position coordinates of an object or motion trace of an object or the like obtained by implementing the above object tracking procedure, to the outside, such as a screen, a printer, a communication network and a remote output device connected thereto, etc.; and a storage apparatus 940 for storing data such as video frames, reliability thresholds, training data, tracking features, tracking performance and feature distributions of tracking features in each of scenes in training data set or the like, by a volatile method or a nonvolatile method, such as various kinds of volatile or nonvolatile memory including a random-access memory (RAM), a read-only memory (ROM), a hard disk and a semiconductor memory.

The basic principle of the present invention is described above with reference to the embodiments. Any one or all of the steps or units of the method or apparatus according to the present invention may be implemented by hardware, software or their combination in any one of computing devices (including a processor, a storage medium, etc.) or a network of computing devices, and it can be implemented by persons skilled in the art who have read the specification of the present application.

Therefore, the present invention may also be realized by a program or a set of programs running on any one of computing devices. The computing devices may be well known general-purpose devices. Therefore, the present invention may also be implemented by providing a program product including program codes for implementing the method or apparatus. That is to say, the program product also belongs to the present invention, and a storage medium storing the program product also belongs to the present invention. Obviously, the storage medium may be any one of well-known storage media or storage media which are to be developed.

In addition, in the apparatus or method of the present invention, units or steps may be divided and/or recombined. The division and/or recombination should be regarded as an equivalent embodiment of the present invention. Steps of the above method may be performed in time order, however the performing sequence is not limited to the time order. Any steps may be performed in parallel or independently.

The present invention is not limited to the specifically disclosed embodiments, and various modifications, combinations and replacements may be made without departing from the scope of the present invention.

The present application is based on and claims the benefit of priority of Chinese Priority Application No. 201310479162.3 filed on Oct. 14, 2013, the entire contents of which are hereby incorporated by reference.

What is claimed is:

1. A method for tracking an object, the method comprising:
tracking, based on a previously selected first tracking feature, the object in a sequence of video frames having the object;
when a scene of the video frame is changed, selecting a second tracking feature with optimal tracking performance for the changed scene; and
continuing tracking the object based on the selected second tracking feature.

2. The method for tracking an object according to claim 1, wherein
selecting the second tracking feature with the optimal tracking performance for the changed scene includes
selecting, based on previously calculated tracking performance of each of the tracking features in each of the scenes of a training data set, the second tracking feature with the optimal tracking performance for the changed scene,
wherein the training data set consists of training video frames in the scenes, the training video frames including the object.

3. The method for tracking an object according to claim 2, wherein
tracking, based on the previously selected first tracking feature, the object in the sequence of the video frames having the object includes
calculating sequentially for every video frame, reliability of a tracking result that is obtained by tracking the object based on the first tracking feature, until a start video frame T with the reliability of the tracking result less than a predetermined reliability threshold, the reliability of the tracking result of a previous video frame T-1 of the start video frame T being greater than or equal to the reliability threshold; and
continuing tracking the object based on the first tracking feature, and calculating the reliability of the obtained tracking result for every video frame, in k video frames after the start video frame T, where k>0.

4. The method for tracking an object according to claim 3, wherein
tracking, based on the previously selected first tracking feature, the object in the sequence of the video frames having the object further includes
determining that the scene of the video frame is changed if the tracking object is missed since a video frame of the k video frames or the reliability of the tracking result of the video frame T+k is still less than the reliability threshold, otherwise continuing tracking the object based on the first tracking feature.

5. The method for tracking an object according to claim 4, wherein
selecting, based on the previously calculated tracking performance of each of the tracking features in each of the scenes of the training data set, the second tracking feature with the optimal tracking performance for the changed scene includes
calculating feature distribution of the first tracking feature in k+1 video frames from the video frame T to the video frame T+k;
calculating distances between the feature distribution and previously calculated feature distribution of the first tracking feature in each of the scenes of the training data set;
determining the scene in the training data set, which corresponds to a minimum distance among the distances; and
determining, based on the previously calculated tracking performance of each of the tracking features in each of the scenes of the training data set, the tracking feature with the optimal tracking performance for the scene in the training data set which corresponds to the minimum distance, serving as the second tracking feature.

6. The method for tracking an object according to claim 2, wherein
for a first video frame at the start of the tracking, the tracking is performed based on the tracking feature with optimal average tracking performance in the whole training data set.

7. The method for tracking an object according to claim 6, wherein
the tracking performance is represented by at least one of tracking accuracy, tracking error, and number of times of tracking failure.

8. A method for selecting a tracking feature used for tracking an object, the method comprising:
selecting the tracking feature with optimal tracking performance for a changed scene, in response to a change of the scene of a video frame having the object.

9. An apparatus for tracking an object, the apparatus comprising:
a feature selection unit configured to select a tracking feature with optimal tracking performance for a changed scene and notify a tracking unit of the tracking feature, when the scene of a video frame is changed; and
the tracking unit configured to track, based on the selected tracking feature, the object in a sequence of the video frames having the object.

10. The apparatus for tracking an object according to claim 9, wherein
the feature selection unit selects, based on previously calculated tracking performance of each of the tracking features in each of the scenes of a training data set, the tracking feature with the optimal tracking performance for the changed scene,
wherein the training data set consists of training video frames in the scenes, the training video frames including the object.
